(19) United States
(12) Patent Application Publication
(10) Pub. No.: US 2004/0010902 A1
(43) Pub. Date: Jan. 22, 2004

(54) Removable, temporary safety barrier

(76) Inventors: David Michael Budd, League City, TX (US); Marvin Douglas Leber, Houston, TX (US)

Correspondence Address: Gary R. Maze, Duane Morris LLP, Suite 500, One Greenway Plaza, Houston, TX, 77046, US

(21) Appl. No.: 10/198,467

(22) Filed: Jul. 18, 2002

(51) Int. Cl. B23P 11/02

(52) U.S. Cl. 29/448

(57) ABSTRACT

A removable barrier, which can be used as a temporary safety barrier, comprises a material having a predetermined perimeter and a tensioner which is disposed about the perimeter of the material to removably secure the flexible material proximate an opening in a desired surface. Color, lettering, and/or logos or combinations thereof may be provided on one or more facings of the material. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### BACKGROUND OF THE INVENTION

The present invention relates to a removable, temporary safety barrier.

It is often desirable to obstruct an opening such as to a tubular or doorway for a temporary period of time. For example, noxious fumes or materials may be present in the tubular or delicate or dangerous operations may be occurring beyond the doorway. For example, these conditions may exist when a tubular is being serviced or when an area behind an opening has become temporarily inaccessible.

Current temporary barriers are usually barricade fencing or barricade tape. These most often do not offer an adequate surface on which to display warning and/or instructional messages and are not easily securable against the opening to remain in place for a desired length of time. Often lacking any tensioner, these barriers become dislodged, such as by wind, and their effectiveness as a barrier is diminished if not eliminated.

### BRIEF DESCRIPTION OF THE DRAWINGS

The features, aspects, and advantages of the present invention will become more fully apparent from the following description, appended claims, and accompanying drawings in which:

FIG. 1 is a plan view in partial perspective of an embodiment of the present invention;

FIG. 2 is a frontal view in partial perspective of an embodiment of a system employing the present invention;

FIG. 3 is a plan view in partial perspective of an embodiment of a system employing the present invention; and

FIG. 4 is a flowchart of a method of use of an exemplary embodiment.

### DETAILED DESCRIPTION OF THE PREFERRED EMBODIMENT

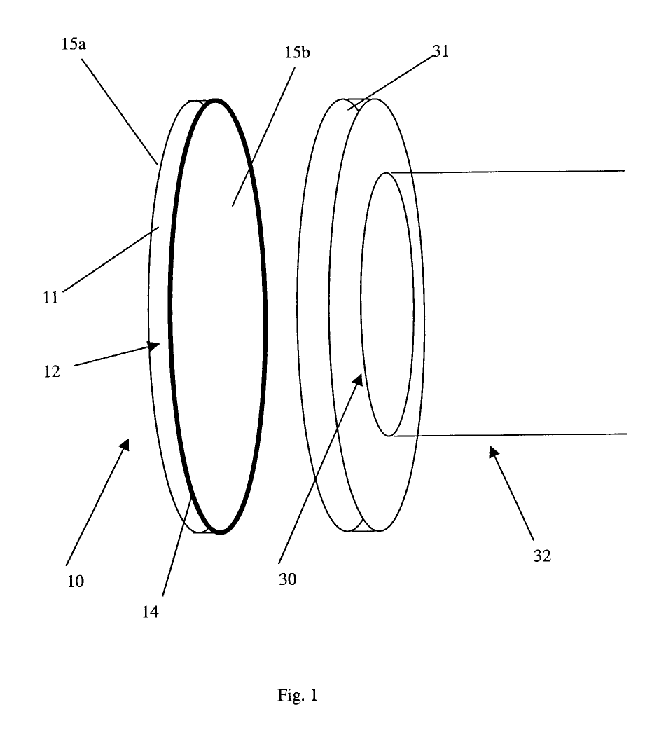

Referring now to FIG. 1, removable barrier 10 comprises material 11 having perimeter 12 of a predetermined dimension and tensioner 14. Removable barrier 10 may be removably secured proximate an opening in a desired surface such as opening 30.

Material 11 may be selected for ease of manufacture and low cost. In a preferred embodiment, material 11 comprises a lightweight material capable of withstanding a predetermined fluid force, e.g. a natural fiber, plastic, vinyl, polypropylene, polyethylene, or the like, or combinations thereof. In certain embodiments, material 11 has a predetermined flexibility.

Perimeter 12 may be made of various sizes for varying openings 30. When secured, perimeter 12 of removable barrier 10 is disposed substantially about all of a perimeter of opening 30, e.g. perimeter 31.

Material 11 may also be provided with one or more openings 13 in facing 15a,15b. Openings 13 may be used to allow air or other fluids present at opening 30 to pass through opening 30 and removable safety barrier 10, e.g. air.

Tensioner 14 is disposed about perimeter 12 of material 11. Tensioner 14 may be elastic such as an elastic ribbon or cord, a non-elastic drawstring, a flexible or adjustable clamp, or the like, or a combination thereof. For example, a cloth or rope drawstring may be used, depending on the environment into which removable barrier 10 is to be placed.

To aid in safety, facings 15a,15b may be provided with a predetermined color such as red or fluorescent orange, a predetermined opacity, lettering 16 such as a warning or instructions, a logo, or the like, or a combination thereof.

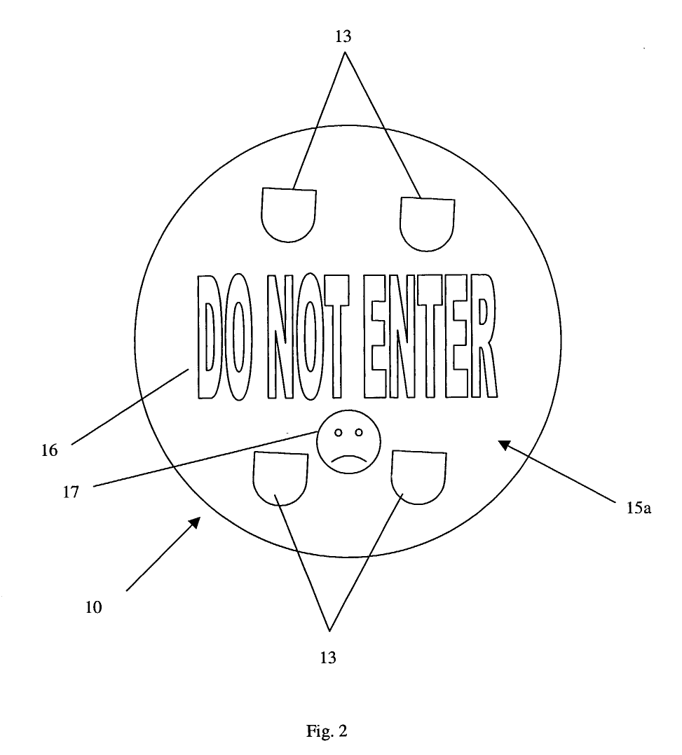

Referring additionally to FIG. 2, lettering 16 may be chosen from a color that will provide a desired contrast against the color of facing 15a,15b. Lettering 16 may also provide for warnings and/or other instructions regarding entry or denial of entry into opening 30, e.g. “DO NOT ENTER” or “WARNING.”

Although in a preferred embodiment, removable barrier 10 is substantially circular, removable barrier 10 may be made in many shapes, e.g. rectangular, oval, and triangular.

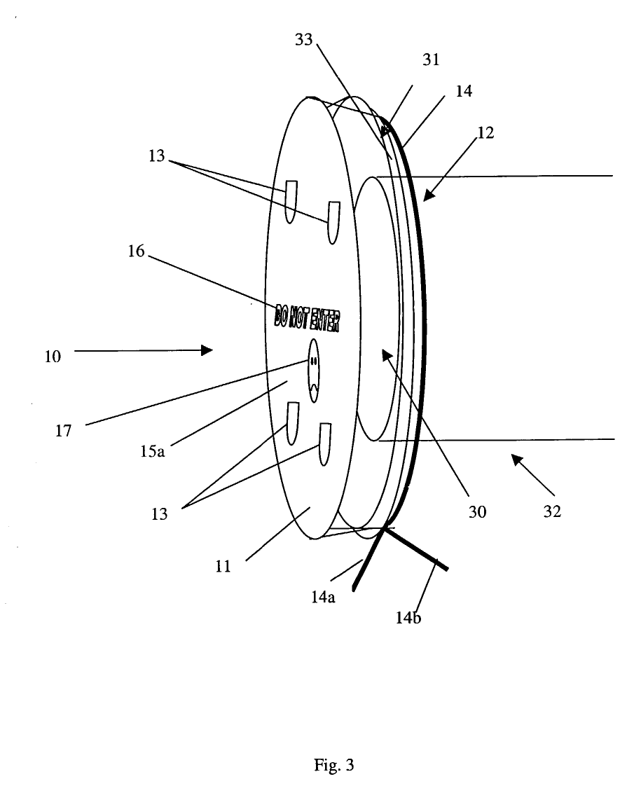

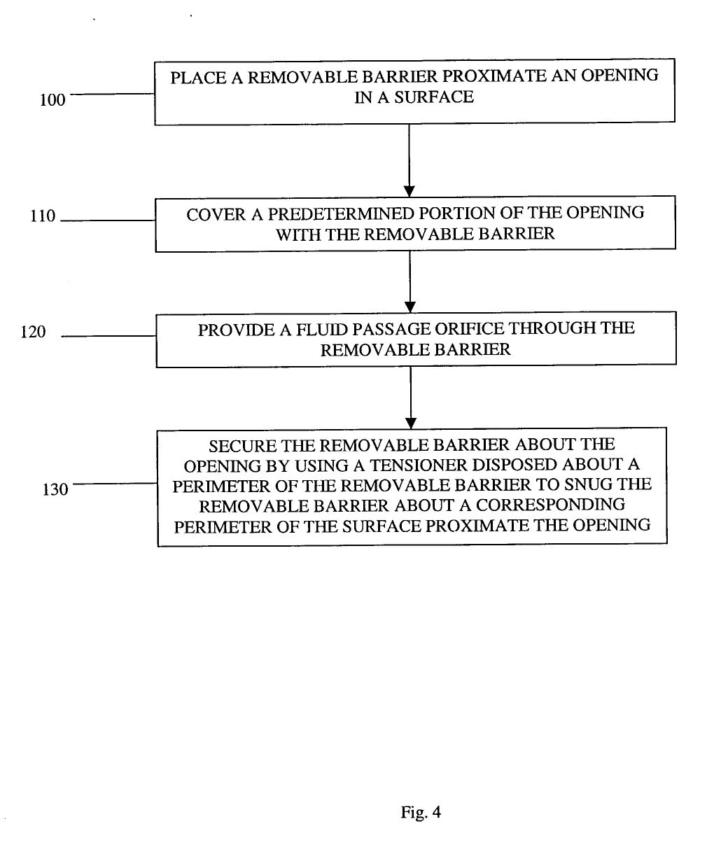

In the operation of a preferred embodiment, referring now additionally to FIG. 3 and FIG. 4, it is often desirable to provide a temporary safety barrier to an opening such as for a pipe or other tubular, e.g. 32 in FIG. 3, an entryway such as a window or door, or the like, especially where entering the opening may pose a safety hazard. Many times, barrier strips such as ribbons and the like are used for this purpose. These barriers often fail to keep the intended entities out of the opening, e.g. people or animals. Further, many times these barriers are subjected to environmental pressures such as wind and fail at being kept in an appropriate place.

A method for temporarily providing a safety barrier of the present invention comprises placing, step 100 (FIG. 4), removable barrier 10 proximate opening 30 in a surface, e.g. opening 30 in tubular 32. Removable barrier 10 may be selected to be of such as size and having a sufficient perimeter 12 to cover a predetermined portion of opening 30, step 110 (FIG. 4).

One or more a fluid passage openings 13 may be provided, step 120 (FIG. 4), through facing 15 of removable barrier 10 or completely through removable barrier 10, e.g. horseshoe shaped flaps, cutouts, slits, or the like. As appropriate, material 11 may comprise a netting.

Removable barrier 10 may be secured, step 130 (FIG. 4), about opening 30 by using tensioner 14 disposed about perimeter 12 to snug removable barrier 10 about a corresponding perimeter 31 of the surface proximate opening 30. Tensioner 14 may be an elastic rope or cord of the like, having the property of being able to secure removable barrier 10 about opening 30 and prevent removable barrier 10 from being displaced by normal forces such as wind. Tensioner 14 may be totally contained within a portion of perimeter 12, e.g. within a channel that is preformed or otherwise manufactured into perimeter 12 such as by sewing. In alternative embodiments, tensioner 14 may be further adjustable such as by using elastic or non-elastic drawstrings 14a,14b (FIG. 3) having one or more exposed ends. In further alternative embodiments, an adjustable clamp (not shown in the figures) may be used, e.g. a screw-and-slot clamp, to provide greater adherence to opening 30.

Perimeter 12 does not need to be of a shape that is initially congruent with perimeter 31. Perimeter 12 will typically have some flexibility to allow installation and removal of removable barrier 10 about opening 30. Tensioner 14 may be used to snug perimeter 12 about perimeter 31, e.g. removable barrier 10 may be substantially round and opening 30 may be substantially rectangular. Tensioner 14 would then be used to snug round perimeter 12 about square perimeter 31.

Color, lettering 16, logos 17 (FIG. 1), or the like, or combinations thereof, may be provided on one or both facings 15a,15b (FIG. 1) of material 11 to provide further warnings and/or instructions.

If the surface has flange, e.g. 33 in FIG. 3, proximate opening 30, removable barrier 10 may be secured by tensioning perimeter 12 of removable barrier 10 about the surface behind flange 32 such as by using tensioner 14.

It will be understood that various changes in the details, materials, and arrangements of the parts which have been described and illustrated above in order to explain the nature of this invention may be made by those skilled in the art without departing from the principle and scope of the invention as recited in the following claims.

We claim:

1) A removable safety barrier, comprising:
a. a flexible material having:
i. a predetermined perimeter; and
ii. an opening in a facing of the flexible material; and
b. a tensioner, disposed about the perimeter of the flexible material, to removably secure the flexible material proximate an opening in a desired surface substantially about all of a perimeter of the opening.

2) A removable safety barrier according to claim 1, wherein:
a. the flexible material comprises at least one of (i) a natural fiber, (ii) plastic, (iii) vinyl, (iv) polypropylene, or (v) polyethylene.

3) A removable safety barrier according to claim 1, wherein the facing further comprises:
a. at least one of (i) a predetermined color, (ii) a lettering, (iii) an opacity, or (iv) a logo.

4) A removable safety barrier according to claim 1, wherein:
a. the tensioner is at least one of (i) an elastic ribbon, (ii) an elastic cord, (iii) a non-elastic ribbon, (iv) a non-elastic cord, or (iv) a clamp.

5) A removable safety barrier, comprising:
a. a material having a predetermined perimeter;
b. a facing sufficient to cover a predetermined area of an opening in a desired surface; and
c. a tensioner, disposed about the perimeter of the material, to removably secure the material proximate the opening.

6) A removable safety barrier according to claim 5, wherein:
a. the material comprises at least one of (i) a natural fiber, (ii) plastic, (iii) vinyl, (iv) polypropylene, or (v) polyethylene.

7) A removable safety barrier according to claim 5, wherein the facing further comprises:
a. at least one of (i) a predetermined color, (ii) a lettering, (iii) an opacity, or (iv) a logo.

8) A removable safety barrier according to claim 5, wherein:
a. the tensioner is at least one of (i) an elastic cord; (ii) an elastic ribbon, (iii) a non-elastic cord, (iv) a non-elastic ribbon, or (iv) a clamp.

9) A method for temporarily providing a safety barrier, comprising:
a. placing a removable barrier proximate an opening in a surface;
b. covering a predetermined portion of the opening with the removable barrier;
c. providing a fluid passage orifice through the removable barrier; and
d. securing the removable barrier about the opening by using a tensioner disposed about a perimeter of the removable barrier to snug the removable barrier about a corresponding perimeter of the surface proximate the opening.

10) A method according to claim 9, further comprising:
a. supplying a message on a predetermined facing of the removable barrier.

11) A method according to claim 9, wherein:
a. the surface has a flange proximate the opening; and
b. the removable barrier is secured by tensioning the perimeter of the removable barrier about the opening behind the flange.
